(19) United States
(12) Patent Application Publication
(10) Pub. No.: US 2017/0271880 A1
(43) Pub. Date: Sep. 21, 2017

(54) RESILIENCY CONTROLLER FOR FREQUENCY REGULATION IN ISLANDED MICROGRID

(71) Applicant: NEC Laboratories America, Inc., Princeton, NJ (US)

(72) Inventors: Feng GUO, SUNNYVALE, CA (US); Ratnesh SHARMA, FREMONT, CA (US)

(21) Appl. No.: 15/463,829

(22) Filed: Mar. 20, 2017

Related U.S. Application Data
(60) Provisional application No. 62/309,988, filed on Mar. 18, 2016.

(51) Int. Cl. H02J 3/40; H02J 7/00; H02J 3/38

(52) U.S. Cl. CPC H02J 3/40; H02J 3/382; H02J 7/0029; H02J 3/383; H02J 3/385; H02J 2003/388; H02J 2007/0037

(57) ABSTRACT

Aspects of the present disclosure describe structures of, and methods for operating a resiliency controller in an islanded microgrid. The resiliency controller exhibits a dynamic droop algorithm for frequency control, employs multiple modules including a frequency control module for microgrid frequency regulation and a State-of-Charge (SOC) based dynamic droop control unit.

### CROSS REFERENCE TO RELATED APPLICATIONS

This application claims the benefit of U.S. Provisional Patent Application Ser. No. 62/309,988 filed Mar. 3, 2016 which is incorporated by reference as if set forth at length herein.

### TECHNICAL FIELD

This disclosure relates generally to electric power generation, storage and distribution systems and methods. More particularly it pertains to improved frequency regulation in islanded microgrids.

### BACKGROUND

As is known, contemporary electric power generation and distribution now include micro-grid architectures along with significant amounts of renewable energy sources. One advantage of a micro-grid is its ability to run in both grid connected and islanded mode of operation thereby providing higher flexibility and reliability. With increasing popularity of micro-grids and their existence becoming more prominent in existing power systems, more stringent adherence to frequency and voltage standards are important to maintain proper functionality of the electric grid. Accordingly, systems, methods and techniques that address any frequency and/or voltage violations in micro- grids would represent a welcome addition to the art.

### SUMMARY

An advance in the art is made according to aspects of the present disclosure directed to a resiliency controller for frequency regulation in islanded micro-grids.

In sharp contrast to the prior art, a frequency controller according to the present disclosure employs a dynamic droop algorithm for frequency control which advantageously results in improved down-time of the micro-grid such that greater economic benefit(s) from renewable energy sources may be realized.

### BRIEF DESCRIPTION OF THE DRAWING

A more complete understanding of the present disclosure may be realized by reference to the accompanying drawing in which:

FIG. 1 is a schematic block diagram illustrating an illustrative electric energy generation/distribution/management system according to an aspect of the present disclosure;

FIG. 2 is a schematic block diagram illustrating an illustrative resiliency controller for an energy generation/distribution/management system according to an aspect of the present disclosure;

FIG. 3 is a schematic block diagram illustrating a frequency control module according to aspects of the present disclosure;

FIGS. 4(A)-4(F) are series of flow diagrams illustrating operation of dynamic droop control unit according to an aspect the present disclosure;

FIG. 5 is a schematic block diagram of an illustrative computer system on which methods of the present disclosure may operate according to an aspect of the present disclosure;

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Drawing, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGS. comprising the drawing are not drawn to scale.

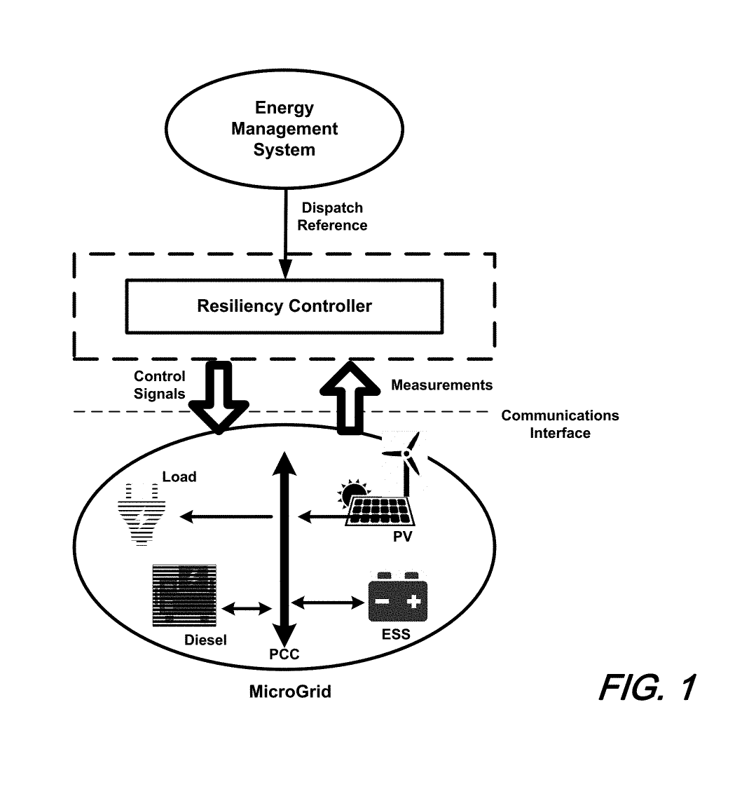

FIG. 1 is a schematic block diagram illustrating an electric energy generation/distribution/management system 100 including a microgrid 110, a resiliency controller 120, and energy management system 130. As may be observed from FIG. 1, the microgrid is shown including traditional diesel generation capabilities, solar photovoltaic generation capabilities and wind generation capabilities, electric storage systems (batteries, etc) and electric loads which generally include electric service customers in a microgrid service area.

Operationally, the energy management system provides active power dispatch reference control(s) for each distributed generator (DG) in the microgrid via communications interface 140 to the resiliency controller. Meanwhile, the resiliency controller collects measurement data from the microgrid via communications interface(s) 145. Based on the dispatch reference(s) and measurement data, the resiliency controller provides control signals to the distributed generators in the microgrid via the communications interface 140.

We note that the energy management system 130 controls the economic operation of the microgrid. Accordingly, by consideration of known energy management concepts of unit commitment, economic dispatch, renewable forecasting, etc., it determines and provides active power dispatch reference(s) to the reresiliency controller for each distributed generator of the microgrid.

With reference to the microgrid illustrated in FIG. 1, we note again that a number of distributed generators are shown namely, renewable—wind, solar, etc, traditional generation including diesel generators, and electrical storage systems (batteries, etc) (ESS). These distributed generators may be classified into thee three categories namely,
1) Category 1—C1—Battery Energy Storage System (ESS);
2) Category 2—C2—Traditional generators using fossil fuels such as diesel generators; and
3) Category 3—C3—Renewable generators, such as photovoltaic (PV) and Wind.

Notably, distributed generators in C1 and C2 are equipped with droop control in their local controllers. Note further that a DGs' output active power is related to the microgrid frequency, while a DGs' output reactive power is related to the microgrid voltage. Equations that may be used to describe these two relationships are as follows:

f_{DG}=f*_{DG}+k_{f}_{_}_{DG}(P*_{DG}−P_{DG}); and

V_{DG}=V*_{DG}+k_{V}_{_}_{DG}(Q*_{DG}−Q_{DG});

where f_{DG} is the output frequency of the DG, f*_{DG} is the reference frequency of the DG, k_{f}_{_}_{DG} is the frequency droop coefficient, P*_{DG} is the reference active power of the DG, and P_{DG} is the output active power of the DG. Meanwhile, V_{DG} is the output frequency of the DG, V*_{DG} is the reference frequency of the DG, k_{V}_{_}_{DG} is the frequency droop coefficient, Q*_{DG} is the reference active power of the DG, and Q_{DG} is the output active power of the DG.

Note that distributed generators categorized in C3 (Renewables) are equipped with Maximum Power Point Tracking (MPPT) methods to harvest the maximum amount of energy under given weather conditions.

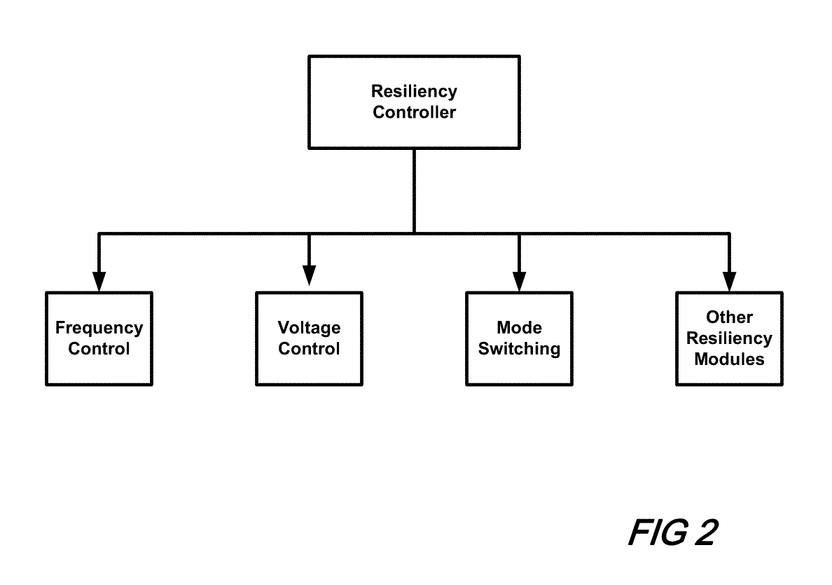

FIG. 2 is a schematic block diagram illustrating a resiliency controller according to an aspect of the present disclosure. As may be observed from that FIG. 2, an illustrative resiliency controller according to the present disclosure includes a number of functional modules namely, frequency control, voltage control, and mode switching modules—among others. These multiple functional modules are advantageously employed to control the distributed generators in a microgrid utilizing any system-level information that may be available. Notably, frequency control module employs a dynamic droop control algorithm to regulate the microgrid frequency. Voltage control module employs a reactive power management algorithm to regulate the microgrid voltage. Mode switching module controls the microgrid operation status transition between grid-tied and islanded mode(s). Other resiliency modules may be advantageously employed to further enhance the overall resilience of the microgrid.

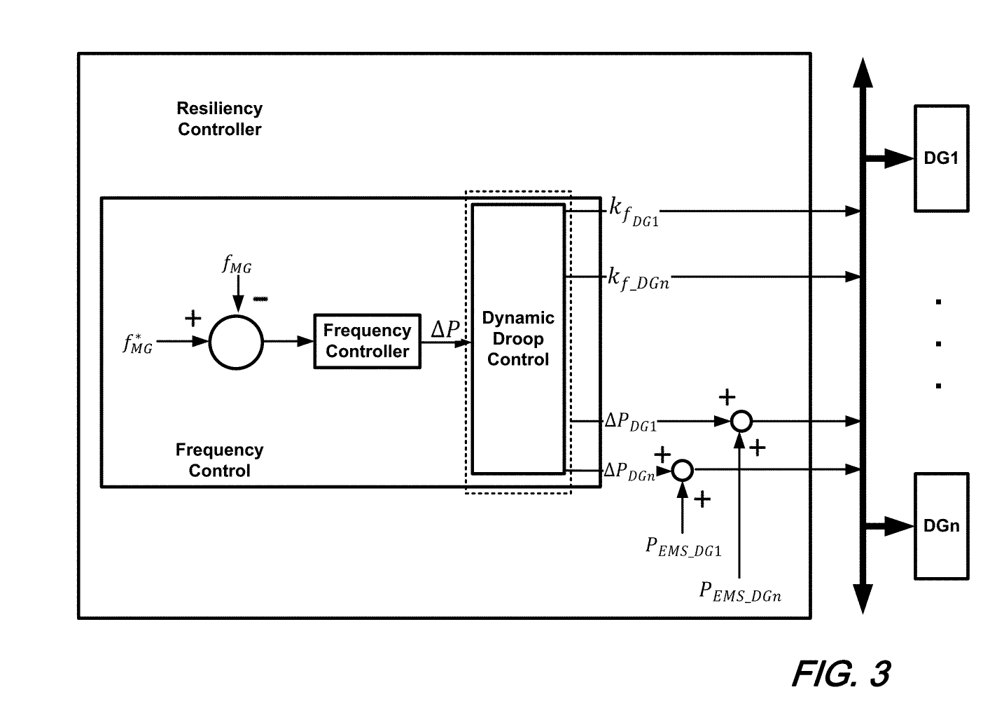

Turning now to FIG. 3, there is shown a schematic block diagram illustrating a frequency control module according to aspects of the present disclosure. As may be observed from that FIG. 3, the reference of the microgrid frequency f*_{MG} is compared with the frequency f_{MG} measured from the microgrid resulting in an error signal. This error signal is provided to the frequency controller which in turn uses that signal to determine the amount of unbalanced active power in the microgrid ΔP. This unbalanced power is provided to a dynamic droop control unit.

The dynamic droop control unit dispatches the amount of unbalanced power between the distributed generators and identifies the amount of power needed for each individual DG, from ΔP_{DG1} to ΔP_{DGn}, which satisfies the following relationship:

ΔP=ΔP_{DG1}+. . . +ΔP_{DGn}.

Meanwhile, the active power references from the energy management system for each DG, from P_{EMS}_{_}_{DG1} to P_{EM}_{_}_{DGn} are added together with ΔP_{DG1} to ΔP_{DGn} respectively resulting in final active power references for each DG, from P*_{DG1} to P*_{DGn}. Note also that the dynamic droop control unit determines the slope rates of droop curves for each DG namely, k_{f}_{_}_{DG1} to k_{f}_{_}_{DGn}.The final active power references and slope rates of droop curves for each DG are sent to each DG from DG1 to DGn by way of the communications link.

With respect to the dynamic droop control unit shown in FIG. 3, we note that a State-of-Charge (SOC) based algorithm is employed therein to determine ΔP_{DG1} to ΔP_{DGn} along with k_{f}_{_}_{DGn}. Of particular distinction from prior art droop control algorithms, the dynamic droop control unit according to the present disclosure can realize the following functions at the same time:
1) Maximize the usage of renewable energies in DG Category 3;
2) Minimize the usage of fossil-fuel generators in DG Category 2;
3) Protect the battery ESS in DG Category.

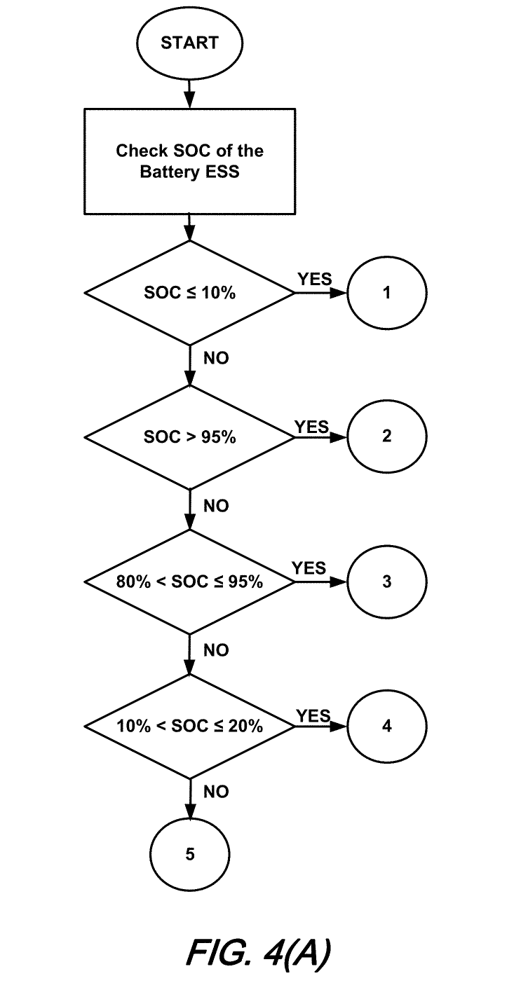

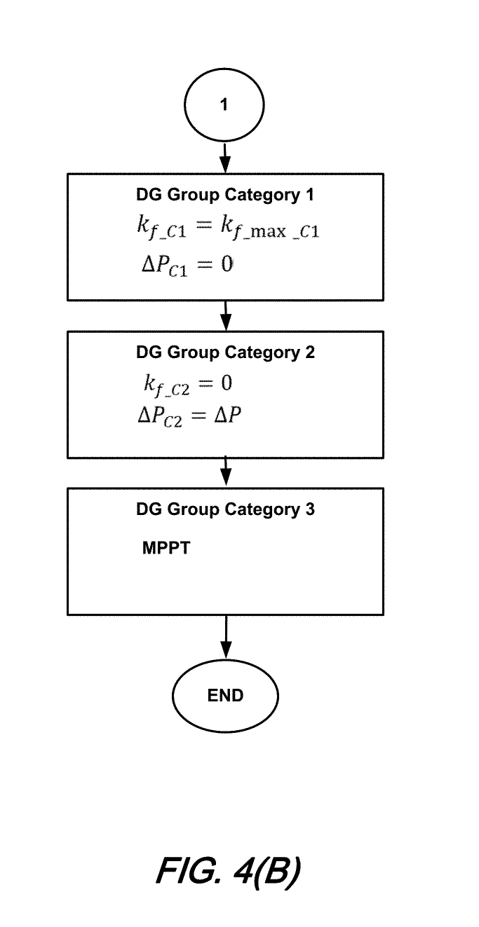

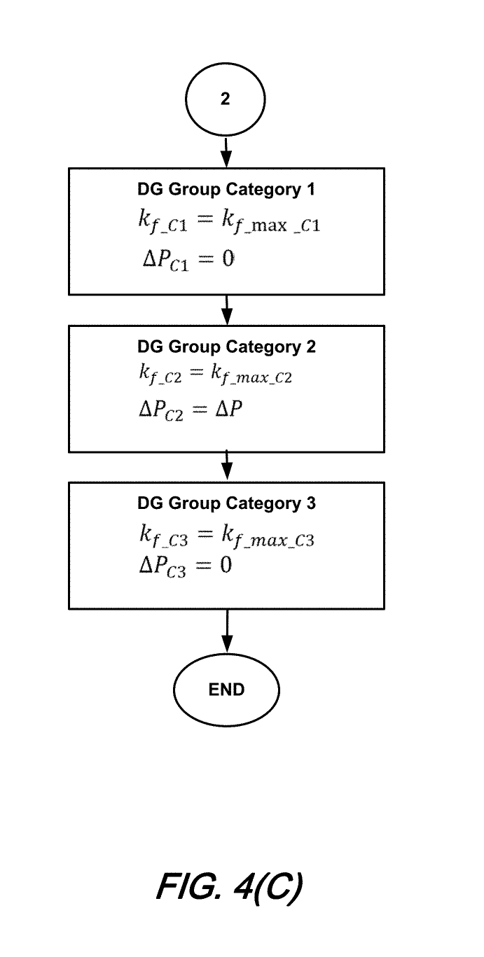

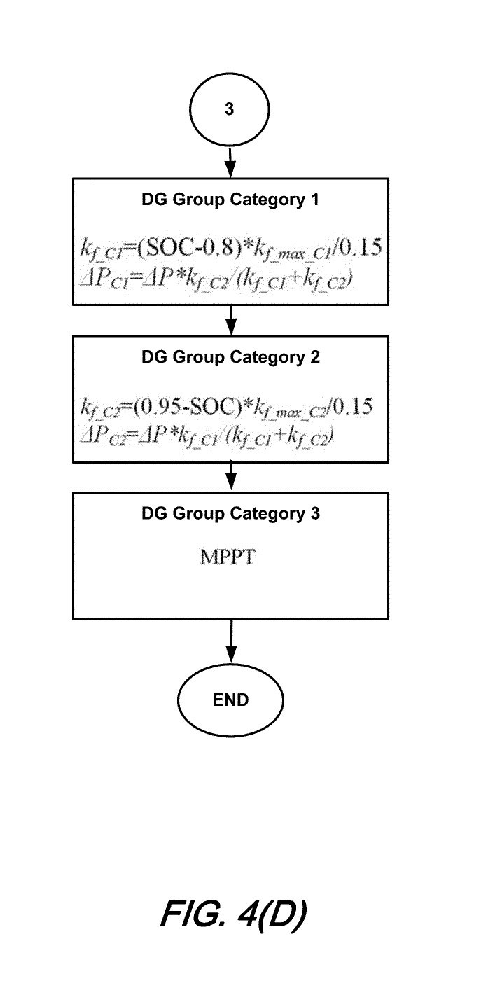

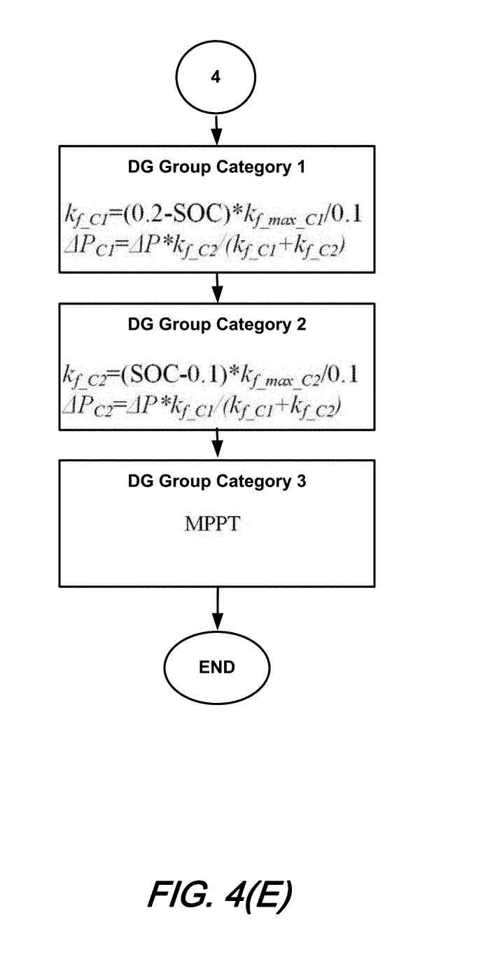

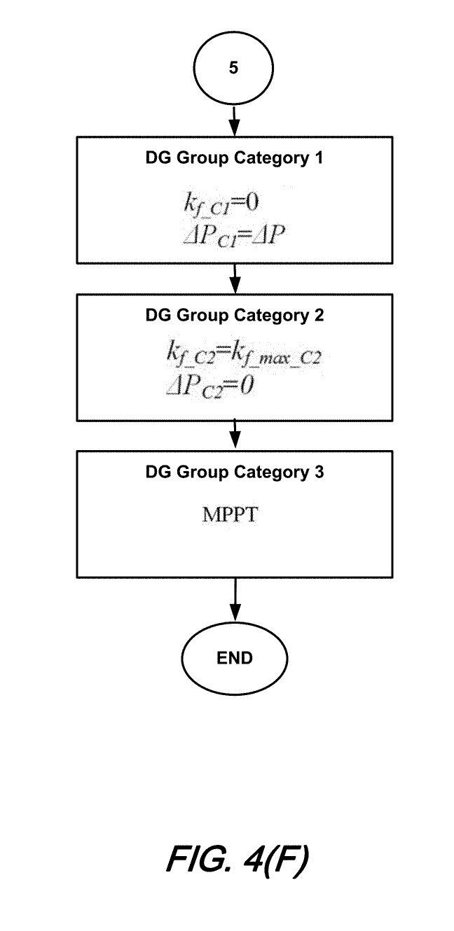

Turning now to FIGS. 4(A)-4(F), there is shown is series of flow diagrams illustrating dynamic droop control according to an aspect of the present disclosure. In this illustrative flow diagram, it is assumed that there is one DG for each of the categories in the microgrid.

As may be observed from simultaneous reference to FIGS. 4(A)-4(F), the method begins in FIG. 4(A) by checking the SOC of the battery ESS in DG Category 1. If SOC <=10%, since the ESS is approaching its depletion state, the DG in Category 2 assumes full responsibility for frequency control. In DG group Category 1 and DG group Category 2, the droop coefficients, k_{f}_{_}_{C1} and k_{f}_{_}_{C2}, and the amount of shared unbalanced power, ΔP_{C1} and ΔP_{C2} determined by the relationships shown in the blocks depicted in FIG. 4(B). Note that DG group Category 3 is operated at MPPT and does not participate in the frequency control at this point.

Alternatively, if SOC>95%, since again the ESS approaches full charge state, the DG in Category 2 will assume full responsibility for frequency control. In DG group Category 1, and DG group Category 2, the droop coefficients, k_{f}_{_}_{C1} and k_{f}_{_}_{C2}, and the amount of shared unbalanced power, ΔP_{C1} and ΔP_{C2} are determined by the relationships shown in the blocks illustrated in FIG. 4(C). In this state, DG group Category 3 also participates in the frequency control to avoid excess power generation from the renewables. Droop control is activated for DG group Category 3, and the droop coefficient k_{f}_{_}_{C3} and the amount of shared unbalanced power ΔP_{C3} are determined by the relationships shown in the blocks shown in FIG. 4(C).

Alternatively, if 80%<SOC<=95%, the ESS has limited frequency control capability since its SOC is at high end. The frequency control responsibility is shared between the ESS and the DG in Category 2 to save certain amount(s) of fossil fuel. Based on the SOC value, in DG group Category 1 and DG group Category 2, the droop coefficients k_{f}_{_}_{C1} and k_{f}_{_}_{C2}, and the amount of shared unbalanced power, ΔP_{C1} and ΔP_{C2} are determined by the relationships shown in the blocks shown in FIG. 4(D). In this state, DG group Category 3 is operated at MPPT and does not participate in the frequency control.

Alternatively, if 10%<SOC<=20%, the ESS has limited frequency control capability since its SOC is at low end. The frequency control responsibility is shared between the ESS and the DG in Category 2 to save fossil fuel. Based on the SOC value, in DG group Category 1 and DG group Category 2 the droop coefficients the droop coefficients k_{f}_{_}_{C1} and k_{f}_{_}_{C2}, and the amount of shared unbalanced power, ΔP_{C1} and ΔP_{C2} are determined by the relationships shown in the blocks shown in FIG. 4(E). DG group Category 3 is operated at MPPT and does not participate in the frequency control.

Else, SOC is between 20% and 80%-which is a safe range. In this state, ESS takes the full responsibility for frequency control, and the fossil fuel consumption in DG group Category 2 can be minimized. The generators in DG group Category 2 can also be shut down to further reduce the fossil fuel consumption, if the amount of power from ESS and DG group Category 3 can support the load. In DG group Category 1 and DG group Category C2, the droop coefficients k_{f}_{_}_{C1} and k_{f}_{_}_{C2}, and the amount of shared unbalanced power, ΔP_{C1} and ΔP_{C2} are determined by the relationships shown in the blocks illustrated in FIG. 4(F). DG group C3 is operated at MPPT and does not participate in the frequency control

Note that as shown in FIGS. 4(A)-4(F), the maximum droop coefficients for each group of DG, k_{f}_{_}_{MAX}_{_{—C1}}, k_{f}_{_}_{MAX}_{_{—C2}}, k_{f}_{_}_{MAX}_{_}_{C3} are determined based on the microgrid requirement and the stability regions and need not have detailed discussion. Finally, if more than one DG is in the same category, a further distribution of the active power between DGs is needed. The DG with largest power rating will take the lead if k_{f} equals zero for that DG group. If k_{f} is not equal to zero, the power will be distributed between different DGs according to their power rating.

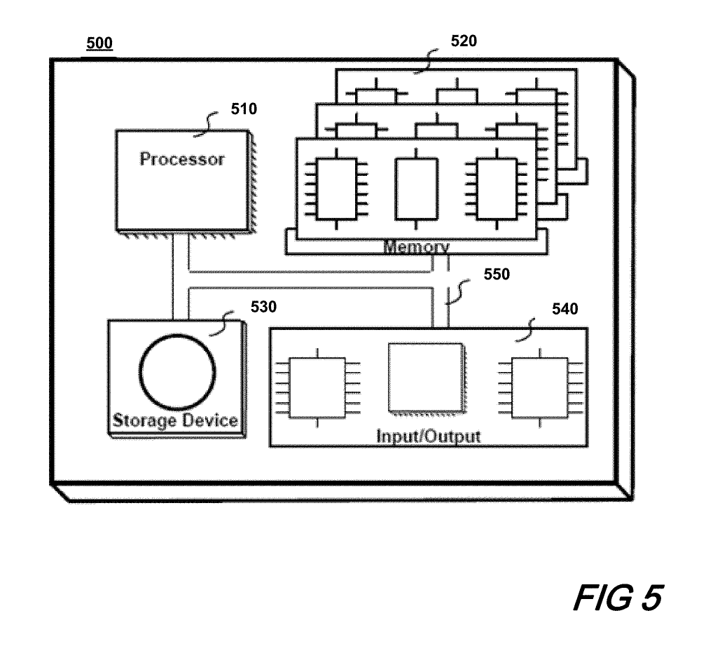

FIG. 5 is a schematic block diagram of an illustrative computer system on which methods of the present disclosure may operate. As may be immediately appreciated, such a computer system may be integrated into another system and may be implemented via discrete elements or one or more integrated components. The computer system may comprise, for example a computer running any of a number of operating systems. The above-described methods of the present disclosure may be implemented on the computer system 500 as stored program control instructions.

Computer system 500 includes processor(s) 510, memory 520, storage device 530, and input/output structure 540. One or more busses 550 typically interconnect the components, 510, 520, 530, and 540. Processor 510 may be a single or multi core and. Additionally, the system may include multiple processors including multiple cores, accelerators etc. Still further, large scale systems of such multiple core, multi-processor systems 500 may be constructed to further enhance any parallelism desired.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations to other systems/structures to which system 500 is communicatively coupled, including resiliency controller functional blocks, and or communication interfaces. Such systems may be included in any or all of the DGs employed as well.

At this point, while we have presented this disclosure using some specific examples, those skilled in the art will recognize that our teachings are not so limited. Accordingly, this disclosure should be only limited by the scope of the claims attached hereto.

1. A resiliency controller for frequency control of an islanded microgrid, the frequency controller comprising:
a plurality of functional modules to control distributed generators in the microgrid utilizing system-level information;
the plurality of functional modules including a frequency control module employing a dynamic droop control methodology to regulate the microgrid frequency.

2. The resiliency controller of claim 1 wherein the frequency control module is configured to receive as input, a signal indicative of microgrid frequency error and determines an amount of unbalanced active power in the microgrid.

3. The resiliency controller of claim 2, wherein the frequency control module includes a dynamic droop control unit configured to receive the microgrid frequency error signal and in response, dispatch an amount of unbalanced power between distributed generators in the microgrid according to the following relationship:
ΔP=ΔP_{DG1}+. . . +ΔP_{DGn}
wherein ΔP is the amount of unbalanced power in the microgrid, ΔP_{DG1} is the amount of unbalanced power dispatched to distributed generator #1 in the microgrid, and ΔP_{DGn} is the amount of unbalanced power dispatched to distributed generator #n in the microgrid.

4. The resiliency controller of claim 3 further configured to generate a final active power reference for each distributed generator in the microgrid.

5. The resiliency controller of claim 4 wherein the dynamic droop control unit is further configured to determine slope rates of droop curves for each of the distributed generators in the microgrid.

6. The resiliency controller of claim 5 further configured to output the final active power references and slope rates of droop curves for each of the distributed generators and output them to the respective distributed generators in the microgrid.

7. The resiliency controller of claim 6 wherein the dynamic droop control unit is further configured to determine a state of charge (SOC) of electric storage systems (ESS) of the microgrid and from that determination maximize the usage of renewable energies in distributed generator Category 3 of the microgrid, minimize the usage of fossil-fuel generators in distributed generator Category 2 of the microgrid, and protect the battery ESS in distributed generator Category 1 in the microgrid from over or under charge; wherein Category 1 of distributed generators in the microgrid includes Battery Energy Storage System (ESS); Category 2 of distributed generators in the microgrid includes traditional generators using fossil fuels; and Category 3 of distributed generators in the microgrid includes renewable generators using photovoltaic (PV) and wind energies.
